(19) United States
(12) Patent Application Publication
(10) Pub. No.: US 2025/0309666 A1
(43) Pub. Date: Oct. 2, 2025

(54) METHODS AND SYSTEMS FOR POWER MANAGEMENT OF BATTERIES IN PARKED VEHICLES

(71) Applicants: HYUNDAI MOTOR COMPANY, Seoul (KR); KIA CORPORATION, Seoul (KR)

(72) Inventor: Su Ho Cho, Hwaseong-si (KR)

(73) Assignees: HYUNDAI MOTOR COMPANY, Seoul (KR); KIA CORPORATION, Seoul (KR)

(21) Appl. No.: 18/804,494

(22) Filed: Aug. 14, 2024

(30) Foreign Application Priority Data
Apr. 2, 2024 (KR) 10-2024-0044547

(51) Int. Cl. H02J 7/00; B60R 16/033; G06N 20/00; H01M 10/42

(52) U.S. Cl. CPC H02J 7/0047; B60R 16/033; G06N 20/00; H01M 10/425; H01M 2010/4271; H01M 2220/20

(57) ABSTRACT

A method for power management of a battery of a parked vehicle includes: storing a charging state of the battery and a point in time at which an engine of the vehicle is turned off, by a first processor included in a battery management unit; inducing the battery management unit to have a sleep mode, by the first processor; monitoring a state of the battery, by a second processor included in a controller; transmitting a wake-up signal to the battery management unit, by the second processor when a specific event occurs; inducing the battery management unit to have a wake-up mode, by the first processor; and deriving a charging rate of the battery, by the first processor.

### CROSS-REFERENCE TO RELATED APPLICATION(S)

This application claims benefit of and priority to Korean Patent Application No. 10-2024-0044547 filed on Apr. 2, 2024 in the Korean Intellectual Property Office, the disclosure of which is incorporated herein by reference in its entirety.

### BACKGROUND

### 1. Field

The present disclosure relates to a method and system for power management of a battery of a vehicle, which is parked.

### 2. Description of Related Art

Even in a vehicle, which is parked, i.e., a vehicle in which an engine is turned off, electric and/or electronic components may operate by receiving power from a battery (for example, a low-voltage battery such as a 12V battery) of the vehicle at all times, periodically, or depending on the occurrence of an event. In recent times, as the number and diversification of electric/electronic components have increased, an amount of power consumed unnecessarily in the parked vehicle may also increase.

In particular, demand has gradually increased for electric/electronic components consuming a large amount of power at all times, such as a built-in dashcam, a black box installed integrally in the vehicle, or the like. Thus, there is a need for a method and system for power management of a battery, which may reduce power consumption of the battery during parking.

### SUMMARY

An aspect of the present disclosure is to increase battery efficiency and extend battery life by reducing unnecessary power consumption of a battery (e.g., a low-voltage battery such as a 12V battery) in a parked vehicle.

An aspect of the present disclosure is to decrease risk of discharge by reducing unnecessary power consumption of a battery (e.g., a low-voltage battery such as a 12V battery) in a parked vehicle.

As a method to solve the above-mentioned problems, an aspect of the present disclosure provides a battery charging guidance method and system according to a type of electric vehicle battery through various embodiments.

According to an aspect of the present disclosure, a method for power management of a battery of a parked vehicle includes: storing a charging state of the battery and a point in time at which an engine of the vehicle is turned off, by a first processor included in a battery management unit; inducing the battery management unit to have a sleep mode, by the first processor; monitoring a state of the battery, by a second processor included in a controller; transmitting a wake-up signal to the battery management unit, by the second processor when a specific event occurs; inducing the battery management unit to have a wake-up mode, by the first processor; and deriving a charging rate of the battery, by the first processor.

In an embodiment, operations (or steps) in the method may be sequentially and repeatedly performed by the first and second processors. A learning unit included in the battery management unit may learn a current consumption pattern of the battery during a time period ranging from a point in time at which the engine of the vehicle is turned off to a point in time at which the engine of the vehicle is turned on again.

In an embodiment, the second processor may store the learned current consumption pattern in a second memory included in the controller.

In an embodiment, the specific event may be a case in which a current deviating from the learned current consumption pattern by an amount equal to or greater than a reference value is detected in the battery.

In an embodiment, the specific event may be a case in which a voltage of the battery is higher than a reference upper limit voltage or lower than a reference lower limit voltage.

In an embodiment, the specific event may be a case in which a temperature of the battery is higher than a reference upper limit temperature or lower than a reference lower limit temperature.

In an embodiment, when the battery management unit has the wake-up mode, and at least one of a voltage or a temperature of the battery exceeds a threshold, the first processor may open a relay between the battery and an electric and/or electronic component mounted on the vehicle.

In an embodiment, the battery may be a low voltage battery.

According to an aspect of the present disclosure, a system for power management of a battery of a parked vehicle includes: a battery management unit: including a first processor and a first memory; and a controller including a second processor and a wake-up pin. The first processor stores a charging state of the battery and a point in time at which an engine of the vehicle is turned off. The first processor induces the battery management unit to have a sleep mode. The second processor monitors a state of the battery and transmits, through the wake-up pin, a wake-up signal to the battery management unit when a specific event occurs to induce the battery management unit to have a wake-up mode. The first processor of the battery management unit induced to have the wake-up mode derives a charging rate of the battery.

In an embodiment, the battery management unit may further include a learning unit. The learning unit may learn a current consumption pattern of the battery during a time period ranging from a point in time at which the engine of the vehicle is turned off to a point in time at which the engine of the vehicle is turned on again.

In an embodiment, the battery management unit may further include a first communication unit and the controller may further include a second communication unit and a second memory. The data of the learned current consumption pattern may be stored in the second memory through the first and second communication units.

In an embodiment, the controller may further include a sensing unit measuring at least one of a current, a voltage, or a temperature of the battery.

In an embodiment, the specific event may be a case in which a current deviating from the learned current consumption pattern by an amount equal to or greater than a reference value is detected in the battery by the sensing unit.

In an embodiment, the specific event may be a case in which the voltage of the battery measured by the sensing unit is higher than a reference upper limit voltage or lower than a reference lower limit voltage.

In an embodiment, the specific event may be a case in which the temperature of the battery measured by the sensing unit is higher than a reference upper limit temperature or lower than a reference lower limit temperature.

In an embodiment, the first processor of the battery management unit induced to have the wake-up mode may open a relay between the battery and an electric and/or electronic component mounted on the vehicle when at least one of a voltage or a temperature of the battery measured by the sensing unit exceeds a threshold.

In an embodiment, the battery may be a low voltage battery.

### BRIEF DESCRIPTION OF DRAWINGS

The above and other aspects, features, and advantages of the present disclosure should be more clearly understood from the following detailed description, taken in conjunction with the accompanying drawings.

FIG. 1 is a conceptual diagram schematically illustrating a power management system in which power is constantly supplied to a battery management unit during parking.

FIG. 2 is a conceptual diagram schematically illustrating a power management system in which a battery management unit has a sleep mode during parking according to an embodiment of the present disclosure.

FIG. 3 is a flowchart illustrating a method for power management of a battery of a parked vehicle according to an embodiment of the present disclosure.

FIG. 4 is a conceptual diagram schematically illustrating a power management system for a battery of a parked vehicle according to an embodiment of the present disclosure.

FIG. 5 is a block diagram illustrating a detailed configuration of a battery management unit according to an embodiment of the present disclosure.

FIG. 6 is a block diagram illustrating a detailed configuration of a controller according to an embodiment of the present disclosure.

FIG. 7 is a graph illustrating a battery current consumption pattern while a vehicle is parked.

FIG. 8 is a graph illustrating a case in which a battery management unit has a wake-up mode while a vehicle is parked.

FIG. 9 is a view illustrating a case in which a specific event occurs during driving and parking of a vehicle over time.

### DETAILED DESCRIPTION

Since the present disclosure may have various changes and may have various embodiments, specific embodiments are illustrated in the drawings and described in detail. However, this is not intended to limit the present disclosure to specific embodiments. It should be understood that the present disclosure includes all modifications, equivalents, and substitutes included in the spirit and scope of the present disclosure.

Terms such as “first,” “second,” and the like may be used to describe various elements, but the elements should not be limited by the terms. The above terms may be used only for the purpose of distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific embodiments and may not be intended to limit the present disclosure. The singular expression may include the plural expression unless the context clearly dictates otherwise. In the present application, terms such as “comprise,” “include,” “have,” and the like are intended to designate that a feature, a number, a step, an operation, a component, a portion, or combination thereof described in the specification exists. However, it should be understood that the existence or addition of one or more other features, numbers, steps, operations, components, parts, or combinations thereof are not excluded in advance.

Unless defined otherwise, all terms used herein, including technical or scientific terms, have the same meaning as commonly understood by one of ordinary skill in the art to which the present disclosure belongs. Terms such as those defined in a commonly used dictionary should be interpreted as having a meaning consistent with the meaning in the context of the related art. Such terms should not be interpreted in an ideal or excessively formal meaning unless explicitly defined in the present disclosure.

In the present specification, a vehicle refers to a variety of vehicles that move an object to be transported, such as people, animals, goods, or the like, from a starting point to a destination. The vehicle is not limited to a vehicle that drives on roads or tracks.

When a component, controller, processor, device, element, unit, member, apparatus, or the like of the present disclosure is described as having a purpose or performing an operation, function, or the like, the component, controller, processor, device, element, unit, member, apparatus should be considered herein as being “configured to” meet that purpose or to perform that operation or function.

Through various embodiments, a battery management unit may be induced to have a sleep mode, to minimize power consumption while a vehicle is parked, e.g., after an engine thereof is turned off. The battery management unit may also be induced to have a wake-up mode according to transmission of a wake-up signal from a controller when a specific event occurs, to perform functions such as check of a battery status, calculation of a battery charging rate, control of a relay, or the like. Therefore, battery efficiency may increase, battery life may extend, and risk of discharge of the battery during parking may be reduced.

Hereinafter, embodiments of the present disclosure are described in more detail with reference to the attached drawings.

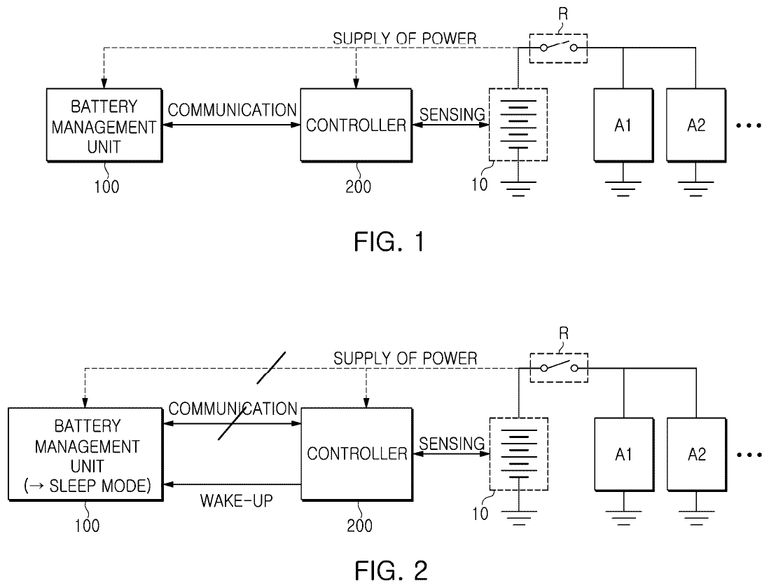

FIG. 1 is a conceptual diagram schematically illustrating a power management system in which power is constantly supplied to a battery management unit during parking.

Referring to FIG. 1, a vehicle may be equipped with a battery 10 supplying power to various electric and/or electronic components A1 and A2 mounted on the vehicle. As an example, the battery 10 may correspond to a 12V battery, but the present disclosure is not limited thereto.

A relay R that may open a circuit in a special situation may be disposed between the battery 10 and the electric/electronic components A1 and A2.

A battery management unit 100 and a controller 200 for monitoring a charging state, a temperature, voltage and/or current, and the like of the battery 10 may also receive the power from the battery 10. The controller 200 may transmit data acquired by sensing a state of the battery 10 to the battery management unit 100. The battery management unit 100 may further calculate a charging state of the battery 10.

When the vehicle is driving, the battery 10 may be charged by driving an engine, but when the vehicle is parked, e.g., after the engine of the vehicle is turned off, the battery 10 may not be charged. Therefore, control for minimizing standby power is needed.

Like a power management system of FIG. 1, when the battery management unit 100 monitors the charging rate of the battery 10 in real time even during parking, power consumption may increase. Therefore, there is a need for a system that a function of the controller 200 disposed between the battery 10 and the battery management unit 100 may be strengthened to optimize power consumption of the battery management unit 100 while the vehicle is parked.

FIG. 2 is a conceptual diagram schematically illustrating a power management system in which a battery management unit has a sleep mode during parking, i.e., over a period when a vehicle is parked, according to an embodiment of the present disclosure.

Referring to FIG. 2, in a power management system for a battery of a vehicle, which is parked, according to an embodiment of the present disclosure, when an engine of the vehicle is turned off, a battery management unit 100 may store a charging state of the battery 10 at this time and the time when the engine was turned off, and may be induced to have a sleep mode.

When the battery management unit 100 is induced to have the sleep mode, power may be no longer supplied from the battery 10, and communication with a controller 200 may also be stopped. In this case, the battery management unit 100 may no longer calculate a charging rate of the battery 10 and may maintain the sleep mode until the engine of the vehicle is turned on again.

When a wake-up signal is received from the controller 200 during parking, the battery management unit 100 may be induced to have a wake-up mode, to perform functions such as calculation of a current charging rate of the battery 10 and/or control of a relay R between the battery 10 and electric/electronic components A1 and A2.

Comparing FIG. 2 with FIG. 1, a battery power management system according to an embodiment may reduce unnecessary power consumption by maintaining the sleep mode without continuously receiving standby power: from the battery 10 by the battery management unit 100 during parking. In addition, only when a specific event occurs as a result of sensing the battery 10 by the controller 200, the battery management unit 100 may receive the wake-up signal from the controller 200 and may have the wake-up mode to calculate the charging rate of the battery 10 at this time. Since the wake-up signal may be transmitted through a simple wake-up pin, instead of a communication module, unnecessary power consumption may also be reduced.

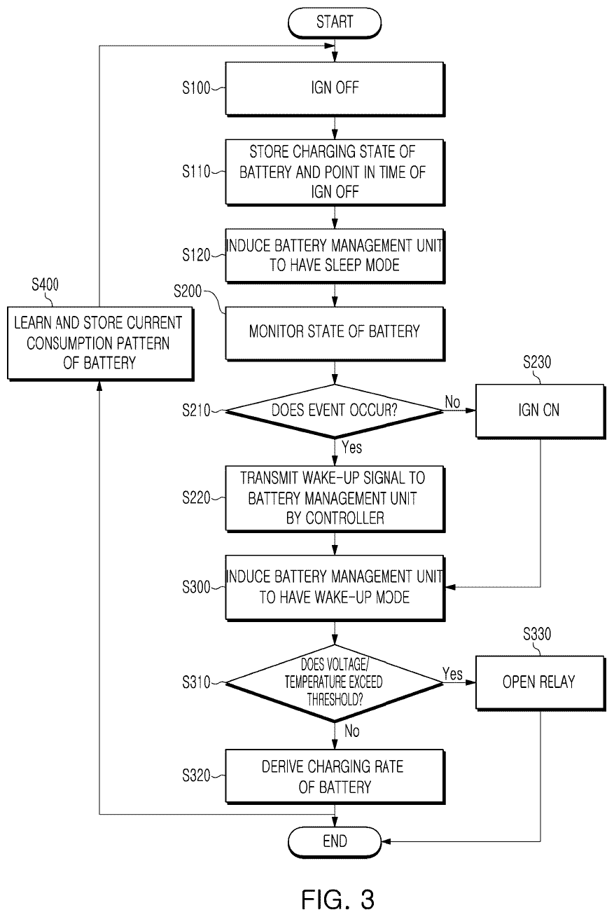

FIG. 3 is a flowchart illustrating a method for power management of a battery of a vehicle, which is parked, according to an embodiment of the present disclosure. FIG. 5 is a view (i.e., a block diagram) illustrating a detailed configuration of a battery management unit according to an embodiment of the present disclosure.

Referring to FIGS. 3 and 5, when an engine of a vehicle is turned off and the vehicle is parked (S100), a first processor 110 included in a battery management unit 100 may store a charging state of a battery 10 and the time, a point in time at which the engine is turned off, in a first memory 130 (S110).

Next, the battery management unit 100, which has finished storing the charging state of the battery 10 and the time at which the engine of the vehicle is turned off, may be induced to have a sleep mode by control of the first processor 110 (S120). When the battery management unit 100 has the sleep mode, power may be no longer supplied from the battery 10, and communication with a controller 200 may be stopped. The sleep mode of the battery management unit 100 may be maintained until an event occurs, such as one of turning on of the engine of the vehicle, or transmission of a wake-up signal from the controller 200.

Next, a second processor 210 included in the controller 200 may monitor a state of the battery 10 (S200). When a specific event occurs as a result of the monitoring (S210), a wake-up signal may be transmitted to the battery management unit 100, which is in the sleep mode (S220).

In this case, a factor to be monitored by the controller 200 may be at least one of a current, a voltage, and a temperature of the battery 10.

In addition, the specific event may be a case in which a current of the battery 10 deviates from a usual current consumption pattern by an amount equal to a reference value or more. In this case, the current consumption pattern of the battery 10 during parking may be data learned by the battery management unit 100 and stored in the controller 200, but the present disclosure is not limited thereto.

Additionally, the specific event may be a case in which a voltage measured in the battery 10 is higher than a reference upper limit voltage or lower than a reference lower limit voltage. In this case, the reference upper limit voltage and the reference lower limit voltage may be appropriately set, depending on a type, a purpose, a use environment, and the like of the battery 10. For example, when the battery 10 is a lead-acid battery, the reference upper limit voltage may be 14.4V to 14.7V and the reference lower limit voltage may be 11.5V to 12.0V. When the battery 10 is a lithium ion battery, the reference upper limit voltage may be 14.4V to 14.6V and the reference lower limit voltage may be 12.0V to 12.6V. When the battery 10 is a lithium iron phosphate battery, the reference upper limit voltage may be 13.6V to 13.8V and the reference lower limit voltage may be 10.0V to 10.5V. However, the present disclosure is not limited to battery type or to these ranges.

Additionally, the specific event may be a case in which a temperature measured in the battery 10 is higher than a reference upper limit temperature or lower than a reference lower limit temperature. In this case, the reference upper limit temperature and the reference lower limit temperature may be appropriately set, depending on a type, a purpose, a use environment, and the like of the battery 10. For example, when the battery 10 is a lead-acid battery, the reference upper limit temperature may be 45° C. to 50° C. and the reference lower limit temperature may be −10° C. to 0° C. When the battery 10 is a lithium ion battery, the reference upper limit temperature may be 60° C. to 70° C. and the reference lower limit temperature may be −20° C. to 0° C. When the battery 10 is a lithium iron phosphate battery, the reference upper limit temperature may be 80° C. to 90° C. and the reference lower limit temperature may be −20° C. to −10° C. However, the present disclosure is not limited to battery type or to these ranges.

Additionally, since the wake-up signal of the controller 200 may be transmitted through a relatively simple wake-up pin, rather than through a communication module, standby power consumption of the battery 10 may be minimized.

When the above-mentioned specific event does not occur as a result of the monitoring, the battery management unit 100 may maintain the sleep mode. When the vehicle ignition is turned on (S230), the battery management unit 100 may be induced to have a wake-up mode.

Next, the first processor 110 of the battery management unit 100 may induce the battery management unit 100 to have the wake-up mode, when either the wake-up signal from the controller 200 is received or the engine of the vehicle is turned on (S300).

When the battery management unit 100 is induced to have the wake-up mode, the battery management unit 100 may receive power from the battery 10 and may communicate with the controller 200 as before having the sleep mode.

Next, as a result of monitoring the battery 10 by the controller 200, when at least one of a voltage or a temperature of the battery 10 exceeds a threshold, the first processor 110 of the battery management unit 100 may open a relay connecting the battery 10 and the electric/electronic components in the vehicle (S330), to eliminate risk factors.

As a result of monitoring the battery 10 by the controller 200, when the voltage and the temperature of the battery 10 are within a normal range, the first processor 110 of the battery management unit 100 may derive a charging rate of the battery 10 at the point in time.

When the battery management unit 100 is not induced to have the sleep mode and continues to be in the wake-up mode, a current of the battery 10 may be sensed in real time by the controller 200. Therefore, the charging rate of the battery 10 may be calculated as follows:

$$SOC ( t ) = SOC ( i ) - \frac{1}{{Q}_{n}} \int Δ Idt \qquad [ Equation 1 ]$$

In Equation 1, SOC(t) refers to a current charging rate of the battery, SOC(i) refers to a charging rate of the battery when the engine is turned off, Qₙ refers to a rated capacity of the battery, and I refers to a real-time current of the battery.

In this case, since the controller 200 should sense the real-time current I of the battery in real time, and since the measured value should be calculated according to Equation 1 above in the battery management unit 100, a certain amount of power consumption of the battery 10 in the battery management unit 100 and the controller 200 may be inevitable.

According to a method for power management of a battery of a vehicle, which is parked, according to an embodiment of the present disclosure, in S320 in which the first processor 110 of the battery management unit 100 derives the charging rate of the battery 10, the charging rate may be calculated by applying the time and a current when the battery management unit 100 is induced to have the wake-up mode. This may be done to derive a charging rate of the battery 10 and a point in time at which the battery management unit 100 is induced to have the wake-up mode even without real-time sensing of the current I.

Next, a learning unit 150 of the battery management unit 100 may sequentially and repeatedly perform S100 to S320, to learn a current consumption pattern of the battery 10 of the parked vehicle, e.g., a current consumption pattern of the battery 10 during a time period ranging from a point in time at which the engine of the vehicle is turned off to a point in time at which the engine of the vehicle is turned on again. Additionally, the current consumption pattern of the battery 10 learned by the learning unit 150 of the battery management unit 100 may be stored in the controller 200.

Learning of the battery management unit 100 may be performed by the learning unit 150 (see FIG. 5), which may be a component of the battery management unit 100. For example, a label may be generated based on past data. Also, supervised learning, which generates a learning model using the same, or unsupervised learning, which learns an inherent pattern of data without a label, may be performed. However, the present disclosure is not limited thereto.

Through such learning by the battery management unit 100, accuracy of predicting the charging rate of the battery 10 based on the current consumption pattern of the vehicle battery 10 while parked may be improved.

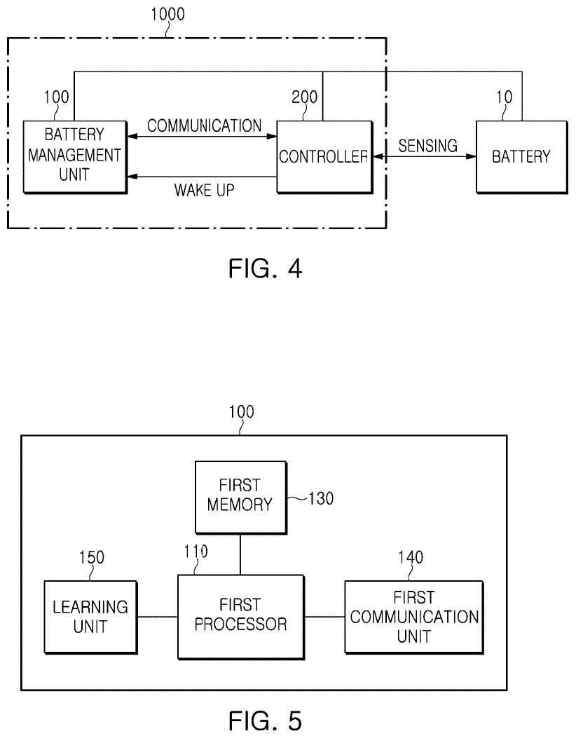

FIG. 4 is a conceptual diagram schematically illustrating a power management system for a battery of a vehicle, which is parked, according to an embodiment of the present disclosure.

Referring to FIGS. 2 and 4, a system for power management of a battery of a vehicle, which is parked, according to an embodiment of the present disclosure, may include a battery management unit 100 and a controller 200.

In an embodiment, the battery management unit 100 and the controller 200 may be connected to the battery 10 of the vehicle, to receive power, and may operate. A battery 10 according to an embodiment may be configured to supply power to a starting system of the vehicle, an ignition system of the vehicle, and electric/electronic components A1 and A2, which may be electronic devices in the vehicle. For example, the battery 10 may be a 12V battery in a form of a lead-acid battery having a capacity of about 40 Ah to 100 Ah, but the present disclosure is not limited thereto.

The battery management unit 100 may operate in a sleep mode or a wake-up mode, depending on a state of the vehicle. The battery management unit 100 may also transmit and receive status information data or the like of the battery 10 by communication with the controller 200. Additionally, the battery management unit 100 may maintain the sleep mode after an engine of the vehicle is turned off and may then switch to have the wake-up mode when receiving a wake-up signal from the controller 200.

The controller 200 may monitor a status of the battery 10. When an abnormality is sensed according to a monitoring result, the controller 200 may transmit the wake-up signal to the battery management unit 100. Therefore, the battery management unit 100 may be configured to calculate a charging rate of the battery 10 or to perform a function such as opening a relay connecting the battery 10 and the electric/electronic components A1 and A2.

FIG. 5 is a view (i.e., a block diagram) illustrating a detailed configuration of a battery management unit according to an embodiment of the present disclosure.

Referring to FIG. 5, a battery management unit 100 of an embodiment may include a first processor 110, and may include a first memory 130, a first communication unit 140, and a learning unit 150, respectively connected to the first processor 110 and controlled by the first processor 110. As an example, the battery management unit 100 may correspond to a battery management system (BMS) included in a vehicle, but the present disclosure is not limited thereto.

When an engine of the vehicle is turned off, the first processor 110 may store a charging state of the battery and a point in time at which the engine of the vehicle is turned off and may induce the battery management unit 100 to have a sleep mode. In addition, when the first processor 110 receives a wake-up signal from the controller 200 or the engine of the vehicle is turned on again, the first processor 110 may convert the battery management unit 100 to have a wake-up mode and may calculate the charging rate of the battery 10 at this point in time.

The first memory 130 may be configured to store data under control of the first processor 110. The first memory 130 may store an initial charging rate of the battery 10 and the time at which the engine is turned off, when parking begins, e.g., when the engine is turned off. After the battery management unit 100 is induced to have the wake-up mode, the first processor 110 may calculate the charging rate of the battery 10 at a point in time of having the wake-up mode, by using the initial charging rate of the battery 10 stored in the first memory 130 and the time spent in the parking state.

The first communication unit 140 may be configured to transmit and receive data and a signal between the battery management unit 100 and the controller 200. The first communication unit 140 may transmit a charging rate of the battery 10 calculated by the first processor 110, after having the wake-up mode of the battery management unit 100, and/or current consumption pattern data of the battery 10 learned by the battery management unit 100 while the vehicle is parked, to the controller 200.

The learning unit 150 may be controlled by the first processor 110. The learning unit 150 may be configured to learn a current consumption pattern of the battery 10 while the vehicle is parked, e.g., from a point in time at which the engine is turned off to a point in time at which the engine is turned on again. For example, the learning unit 150 may generate a label based on past data and may perform supervised learning, which generates a learning model using the same, or unsupervised learning, which learns an inherent pattern of data without a label. However, the present disclosure is not limited thereto.

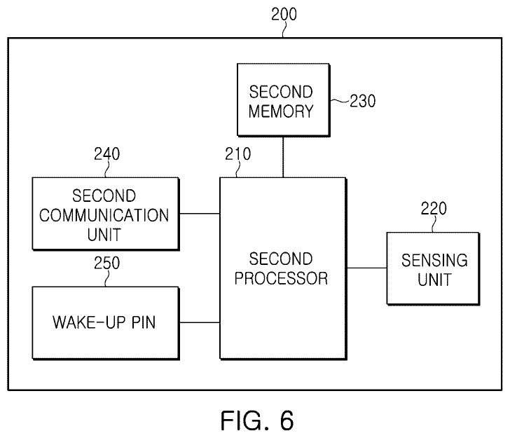

FIG. 6 is a view (i.e., a block diagram) illustrating a detailed configuration of a controller according to an embodiment of the present disclosure.

Referring to FIG. 6, a controller 200 of an embodiment may include a second processor 210, and may include a sensing unit 220, a second memory 230, a second communication unit 240, and a wake-up pin 250, respectively connected to the second processor 210 and controlled by the second processor 210. For example, the controller 200 may correspond to a battery monitoring integrated circuit (BMIC) included in a vehicle, but the present disclosure is not limited thereto.

The second processor 210 may monitor a state of a battery 10 of the vehicle by the sensing unit 220 connected to the battery 10. The sensing unit 220 may measure at least one of a current, a voltage, or a temperature of the battery 10 of the vehicle. Additionally, the second processor 210 may transmit a wake-up signal to a battery management unit 100 through the wake-up pin 250, when a specific event occurs, in the battery 10 of the vehicle in which an engine is turned off.

The specific event may be a case in which a current of the battery 10 deviates from a usual current consumption pattern by an amount equal to a reference value or more. In this case, the current consumption pattern of the battery 10 during parking may be data learned by a first processor 110 of the battery management unit 100 and stored in the second memory 230 of the controller 200, but the present disclosure is not limited thereto.

Additionally, the specific event may be a case in which a voltage of the battery 10 measured by the sensing unit 220 is higher than a reference upper limit voltage or lower than a reference lower limit voltage. In this case, the reference upper limit voltage and the reference lower limit voltage may be appropriately set, depending on a type, a purpose, a use environment, and the like of the battery 10. For example, when the battery 10 is a lead-acid battery, the reference upper limit voltage may be 14.4V to 14.7V and the reference lower limit voltage may be 11.5V to 12.0V. When the battery 10 is a lithium ion battery, the reference upper limit voltage may be 14.4V to 14.6V and the reference lower limit voltage may be 12.0V to 12.6V. When the battery 10 is a lithium iron phosphate battery, the reference upper limit voltage may be 13.6V to 13.8V and the reference lower limit voltage may be 10.0V to 10.5V. However, the present disclosure is not limited to battery type or to these ranges.

Additionally, the specific event may be a case in which a temperature of the battery 10 measured by the sensing unit 220 is higher than a reference upper limit temperature or lower than a reference lower limit temperature. In this case, the reference upper limit temperature and the reference lower limit temperature may be appropriately set, depending on a type, a purpose, a use environment, and the like of the battery 10. For example, when the battery 10 is a lead-acid battery, the reference upper limit temperature may be 45° C. to 50° C. and the reference lower limit temperature may be −10° C. to 0° C. When the battery 10 is a lithium ion battery, the reference upper limit temperature may be 60° C. to 70° C. and the reference lower limit temperature may be −20° C. to 0° C. When the battery 10 is a lithium iron phosphate battery, the reference upper limit temperature may be 80° C. to 90° C. and the reference lower limit temperature may be −20° C. to −10° C. However, the present disclosure is not limited to battery type or to these ranges.

The second memory 230 may receive and store current consumption pattern data of the battery 10 of the parked vehicle learned by a learning unit 150 of the battery management unit 100. Since the current consumption pattern data of the battery 10 of the parked vehicle is stored in the second memory 230, which may be a component of the controller 200, even though the battery management unit 100 is induced to have a sleep mode, power consumption may be relatively low. The second processor 210 of the controller 200, which consumes power, may determine whether a wake-up signal is generated by comparing a monitored result of the battery 10 by the sensing unit 220 with the current consumption pattern data.

The second communication unit 240 may be configured to transmit and receive data with a first communication unit 140 of the battery management unit 100 under control of the second processor 210. The current consumption pattern data of the battery 10 of the parked vehicle learned in the learning unit 150 of the battery management unit 100 may be stored in the second memory 230 sequentially through the first communication unit 140 and the second communication unit 240 to the second memory 230.

The wake-up pin 250 may be configured to transmit the wake-up signal to the battery management unit 100 induced to have the sleep mode under control of the second processor 210. The wake-up pin 250 may consume low power and may have an advantage of a fast response speed. For example, the wake-up pin 250 may be operated by a hardware signal such as a button or switch operation, external device connection, or the like, by a software signal such as sending of an application command or the like, or by a signal such as an interrupt occurring at set time intervals or the like. However, the present disclosure is not limited thereto.

In an embodiment, the first and second processors 110 and 210 may be, for example, a semiconductor device that executes processing of instructions stored in a central processing unit (CPU) or the first and second memories 130 and 230. An operation of a method or algorithm described in connection with embodiments of the present disclosure may be implemented directly in a hardware module, a software module, or a combination of the two executed by the first and second processors 110 and 210. The software module may be disposed in a storage medium such as an RAM memory, a flash memory, an ROM memory, an EPROM memory, an EEPROM memory, a register, a hard disk, a solid state drive (SSD), a removable disk, or a CD-ROM. As an example, the storage medium may be coupled to first and second processors 110 and 210. The first and second processors 110 and 210 may read information from the storage medium and may write information to the storage medium. Alternatively, the storage medium may be integrated with the first and second processors 110 and 210. The first and second processors 110 and 210 and the storage medium may be disposed in an application specific integrated circuit (ASIC). The ASIC may be disposed in a user terminal. Alternatively, the first and second processors 110 and 210 and the storage medium may be disposed as separate components in the user terminal.

The first and second memories 130 and 230 may include, for example, at least one of a memory such as a flash memory type, a hard disk type, a micro type, a card type (e.g., a secure digital (SD) card or an extreme digital (xD) card), or the like, or a memory such as a random access memory (RAM), a static RAM (SRAM), a read only memory (ROM), a programmable ROM (PROM), an electrically erasable PROM (EEPROM), a magnetic RAM (MRAM), a magnetic disk, and an optical disk type memory, but the present disclosure is not limited thereto.

The first and second communication units 140 and 240 may be configured to perform, for example, vehicle network communication such as controller area network (CAN) communication, a local interconnect network (LIN) communication, and/or flex-ray communication, or the like, but the present disclosure is not limited thereto.

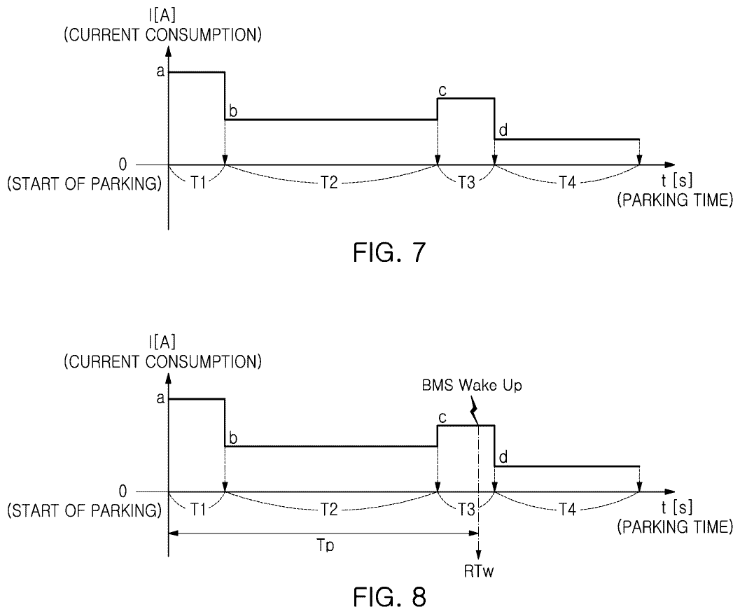

FIG. 7 is a graph illustrating an example of a battery current consumption pattern while a vehicle is parked.

Referring to FIG. 7, a horizontal axis of a graph represents a parking time t and a unit thereof is seconds (sec). A vertical axis thereof represents a current I consumed in a battery 10 and a unit thereof is ampere (A).

Electric and/or electronic components (i.e., electric/electronic components) mounted on a vehicle may generally perform periodic or continuous operations while parked and may exhibit a constant current consumption pattern. For example, there may be a constant current consumption pattern over time, such as: power consumption after starting parking, e.g., after an engine is turned off, until controllers of the electric and/or electronic components are induced to have a sleep state, respectively; power consumption due to an operation such as shooting with a built-in cam or the like, which may be an integrated black box; or power consumption due to a periodic wake-up operation of each of the controllers of the electric/electronic components. This may be changed depending on a type of vehicle, an option of an electric/electronic component, or the like.

Referring to FIG. 7, assuming a parking start time is 0, a light, a window, a sunroof, a memory seat, or the like may need to operate for a certain time period immediately after an engine is turned off. There may also be an operation such as an after-blow operation or the like for drying an air conditioner. Therefore, current consumption may be used in a current of a during a T1 time period. Thereafter, power supply to a portion of the electric/electronic components may be cut off, and a current of b, lower than the current of a, may be maintained during a T2 time period. During a T3 time period when electric/electronic components that operate periodically operate, a current of c, higher than the current of b, may be consumed, and then power to most electric/electronic components may be cut off, except for electric/electronic components that require a constant operation, such as an operation of a built-in cam, remote control, or the like. Then, the lowest current of d may be maintained during a T4 time period. Such a pattern is illustrative, and various current consumption patterns may exist.

FIG. 8 is a graph illustrating a case in which a battery management unit has a wake-up mode while a vehicle is parked.

Referring to FIG. 8, when a vehicle having the current consumption pattern of FIG. 7 is parked, a specific event may occur at RTw and a battery management unit 100 may switch from a sleep mode to a wake-up mode. The specific event may be a case in which a controller 200 sensing a battery 10 of the parked vehicle detects a current deviate from a current consumption pattern or detects a voltage or a temperature exceeding a reference value. However, the present disclosure is not limited thereto.

The battery management unit 100 having the wake-up mode may calculate a charging rate of the battery at the point in time, and the formula may be as follows.

$$SOC ( t ) = SOC ( i ) - \frac{\{ a \times T 1 + b \times T 2 + c \times ( Tp - T 1 - T 2 ) \}}{{Q}_{n}} \qquad [ Equation 2 ]$$

In Equation 2, SOC(t) refers to a current charging rate of the battery, SOC(i) refers to a charging rate of the battery when the engine is turned off, Qₙ refers to a rated capacity of the battery, a refers to current consumption during a T1 time period, b refers to current consumption during a T2 time period, and c refers to current consumption at a point in time when the battery management unit is woken up. Tp refers to a time period in which a parking state is maintained and corresponds to a time period from a parking start time to a wake-up time RTw.

As illustrated in Equation 2 above, when SOC(i), which may be the charging rate of the battery at a point in time when the battery management unit 100 has the sleep mode, and the time at that time, are stored, and when a learned current consumption pattern is applied, SOC(t), which may be the charging rate of the battery at the wake-up time RTw, may be derived, even without continuously sensing the consumption current I.

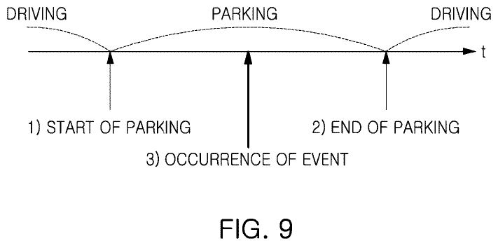

FIG. 9 is a view illustrating a case in which a specific event occurs during driving and parking of a vehicle over time.

Referring to FIG. 9, a vehicle may alternately perform operations of driving-parking-driving. A parking start time may correspond to a point in time when an engine of the vehicle is turned off. A parking end time may correspond to a point in time when the engine of the vehicle is turned on again.

When a battery management unit 100 of the vehicle maintains a wake-up mode throughout a parking state, unnecessary power consumption may increase. A method and system for power management of a battery of a vehicle, which is parked, according to embodiments of the present disclosure, may be induced to have and maintain a sleep mode when an engine of the vehicle is turned off. Only when a specific event requiring intervention of the battery management unit 100 occurs between the parking start time and the parking end time, the battery management unit 100 of the vehicle may receive a wake-up signal from a controller 200 and convert the same to have a wake-up mode to perform a function thereof. Unnecessary power consumption during parking is thereby reduced.

According to an aspect of the present disclosure, battery efficiency may increase, and battery life may increase, by reducing unnecessary power consumption of a battery (e.g., a low-voltage battery such as a 12V battery) in a vehicle, which is parked.

According to another aspect of the present disclosure, risk of discharge may decrease by reducing unnecessary power consumption of a battery (e.g., a low-voltage battery such as a 12V battery) in a vehicle, which is parked.

While embodiments have been illustrated and described above, it should be apparent to those having ordinary skill in the art that modifications and variations could be made without departing from the scope of the present disclosure as defined by the appended claims.

What is claimed is:

1. A method for power management of a battery of a parked vehicle, the method comprising:
storing a charging state of the battery and a point in time at which an engine of the vehicle is turned off, by a first processor included in a battery management unit;
inducing the battery management unit to have a sleep mode, by the first processor;
monitoring a state of the battery, by a second processor included in a controller;
transmitting a wake-up signal to the battery management unit, by the second processor, when a specific event occurs;
inducing the battery management unit to have a wake-up mode, by the first processor; and
deriving a charging rate of the battery, by the first processor.

2. The method of claim 1, wherein:
steps in the method are sequentially and repeatedly performed by the first and second processors; and
a learning unit included in the battery management unit learns a current consumption pattern of the battery during a time period ranging from a point in time at which the engine of the vehicle is turned off to a point in time at which the engine of the vehicle is turned on again.

3. The method of claim 2, wherein the second processor stores the learned current consumption pattern in a second memory included in the controller.

4. The method of claim 2, wherein the specific event is a case in which a current deviating from the learned current consumption pattern by an amount equal to or greater than a reference value is detected in the battery.

5. The method of claim 1, wherein the specific event is a case in which a voltage of the battery is higher than a reference upper limit voltage or lower than a reference lower limit voltage.

6. The method of claim 1, wherein the specific event is a case in which a temperature of the battery is higher than a reference upper limit temperature or lower than a reference lower limit temperature.

7. The method of claim 1, wherein, when the battery management unit has the wake-up mode, and when at least one of a voltage or a temperature of the battery exceeds a threshold, the first processor opens a relay between the battery and an electric and/or electronic component mounted on the vehicle.

8. The method of claim 1, wherein the battery is a low voltage battery.

9. A system for power management of a battery of a vehicle, which is parked, the system comprising:
a battery management unit including a first processor and a first memory; and
a controller including a second processor and a wake-up pin,
wherein the first processor is configured to store a charging state of the battery and a point in time at which an engine of the vehicle is turned off, and is configured to induce the battery management unit to have a sleep mode,
wherein the second processor is configured to monitor a state of the battery and transmit, through the wake-up pin, a wake-up signal to the battery management unit when a specific event occurs to induce the battery management unit to have a wake-up mode, and
wherein the first processor of the battery management unit induced to have the wake-up mode is configured to derive a charging rate of the battery.

10. The system of claim 9, wherein:
the battery management unit further includes a learning unit, and
wherein the learning unit is configured to learn a current consumption pattern of the battery during a time period ranging from a point in time at which the engine of the vehicle is turned off to a point in time at which the engine of the vehicle is turned on again.

11. The system of claim 10, wherein:
the battery management unit further includes a first communication unit,
the controller further includes a second communication unit and a second memory, and
data of the learned current consumption pattern is stored in the second memory through the first and second communication units.

12. The system of claim 10, wherein the controller further includes a sensing unit measuring at least one of a current, a voltage, or a temperature of the battery.

13. The system of claim 12, wherein the specific event is a case in which a current deviating from the learned current consumption pattern by an amount equal to or greater than a reference value is detected in the battery by the sensing unit.

14. The system of claim 12, wherein the specific event is a case in which the voltage of the battery measured by the sensing unit is higher than a reference upper limit voltage or lower than a reference lower limit voltage.

15. The system of claim 12, wherein the specific event is a case in which the temperature of the battery measured by the sensing unit is higher than a reference upper limit temperature or lower than a reference lower limit temperature.

16. The system of claim 12, wherein the first processor of the battery management unit induced to have the wake-up mode is configured to open a relay between the battery and an electric and/or electronic component mounted on the vehicle, when at least one of a voltage or a temperature of the battery measured by the sensing unit exceeds a threshold.

17. The system of claim 9, wherein the battery is a low voltage battery.
